(19) United States
(12) Patent Application Publication
(10) Pub. No.: US 2010/0003648 A1
(43) Pub. Date: Jan. 7, 2010

(54) Reckon behavior

(76) Inventor: Willie Mann, Ellenwood, GA (US)

Correspondence Address: Willie Mann, 5588 Thurgood Ct., Ellengood, GA, 30294, US

(21) Appl. No.: 12/217,444

(22) Filed: Jul. 3, 2008

(51) Int. Cl. G09B 19/22

(52) U.S. Cl. 434/128

(57) ABSTRACT

Reckon Behavior is a broad game with 49 separate illustrated conditions that could possibly occur in an individual lifetime as a result of an individual poor choice in judgment.

The game begins on the first marked illustration (1)—I'm just going up the road for a minute and ends on illustration marked (49) Don't forget to play the tape.

38 of the 49 conditions on the board game consist of individual illustrated drawing to show the progressive nature of addiction. The purpose of the game helps to establish and guide an individual toward making better choices in life. The learning valve of the game comes from the negative aspects to the game from the penalties imposed on each player when he/she move their playing piece to a high risk behavior event such as: jail event, institution event, court event or high risk behavior event.

This invention is concerned with the process of making people aware of the high-risk behavior leading to jail, Institution and or death in the United States and other territories. Reckon Behavior is a visual learning aid that can educate society by providing real life situation of potentially dangerous high risk behavior and situations without having to suffer such Action. Since many of us practice and or exercise high risk behavior daily, it is beneficial that we provide the people an advantage of learning the possible unpredictable situations before experiencing true life situations. This game can be used during treatment and in the privacy of one's home or meeting place. Participants will be able to share with other family members the values they can gain with participation.

### SUMMARY OF THE INVENTION

One out three people today is dealing with some form of serious addiction cause as a Result of high-risk behavior. My mission is to educate people with Reckon Behavior issues And inform those individual of the possible high-risk consequences resulting from high risk Behavior. I believe healthy bodies promote better minds and better people. This board game Reduces many of the barriers in educating people on the nature of high-risk behavior. I am Optimistic that providing Reckon Behavior as an educational and learning aid, I can help both families and business communities. Addiction usually strikes without warning and youth's think this activity is all part of the norm. When it hits, no matter how young or old, the end results are predictably the same: jail, institution and or death.

### BRIEF DESCRIPTION OF THE DRAWING

FIG. 1 is flat view of board game

FIG. 2 is pieces used by player

FIG. 3 is the 5 different amounts of money for the game

FIG. 4 is the 38 individual drawing on board game

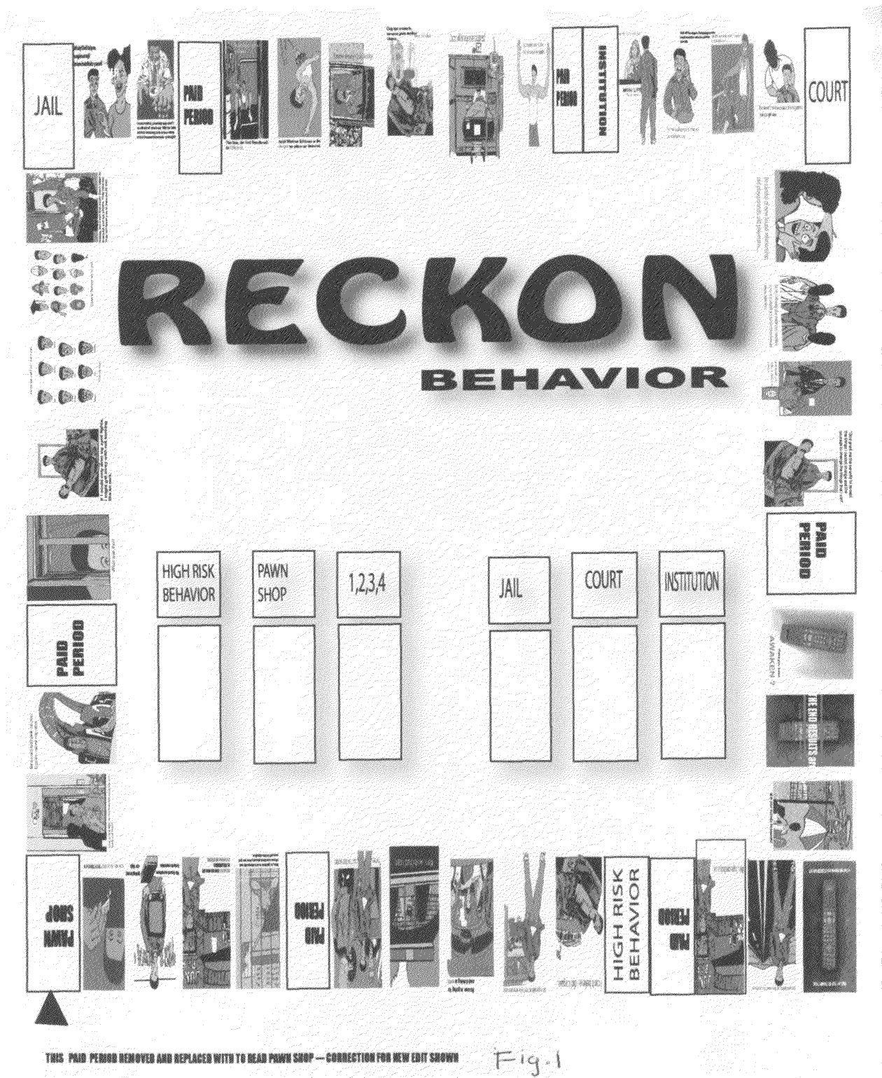

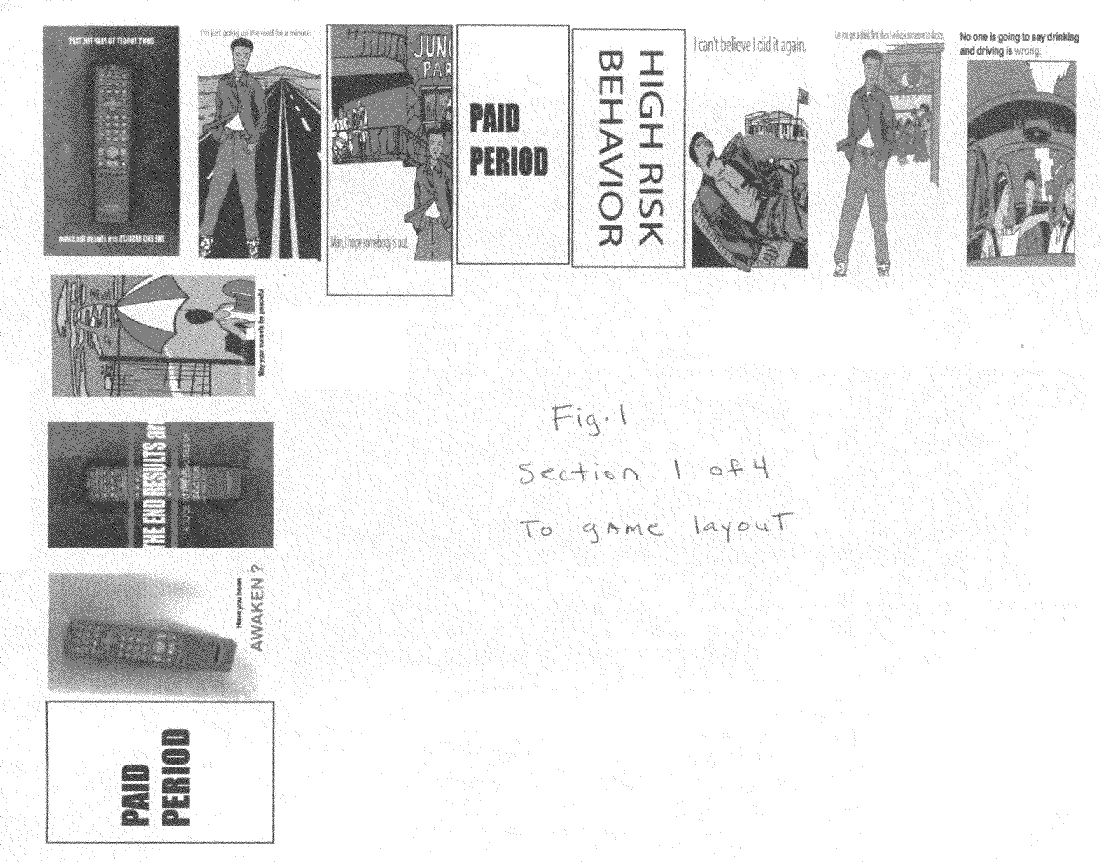

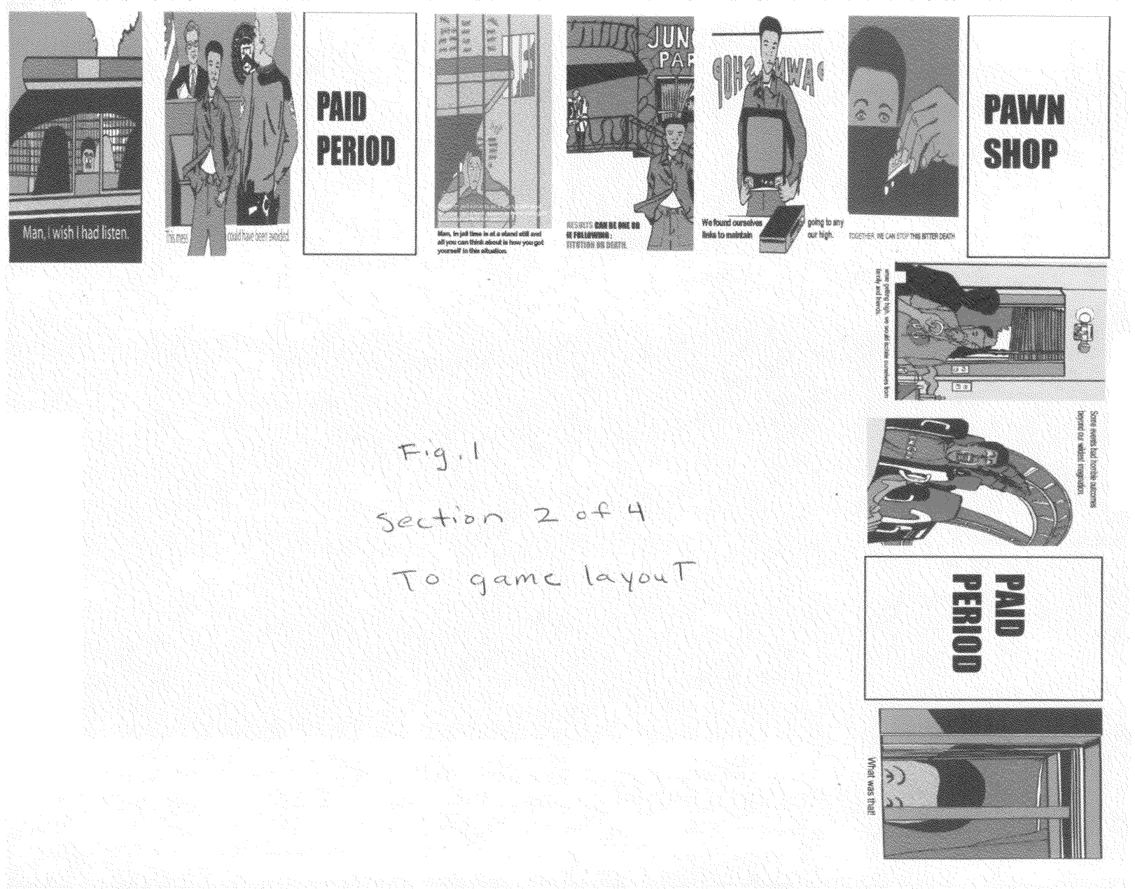

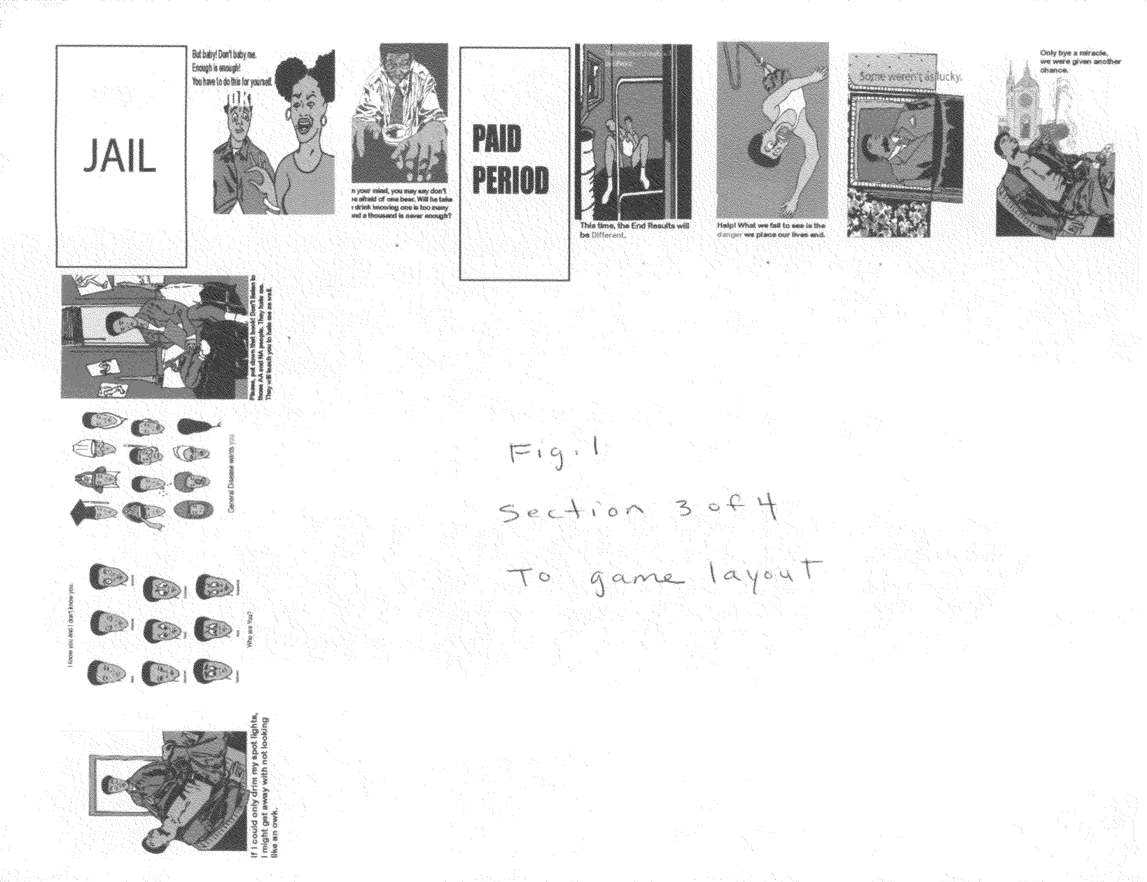

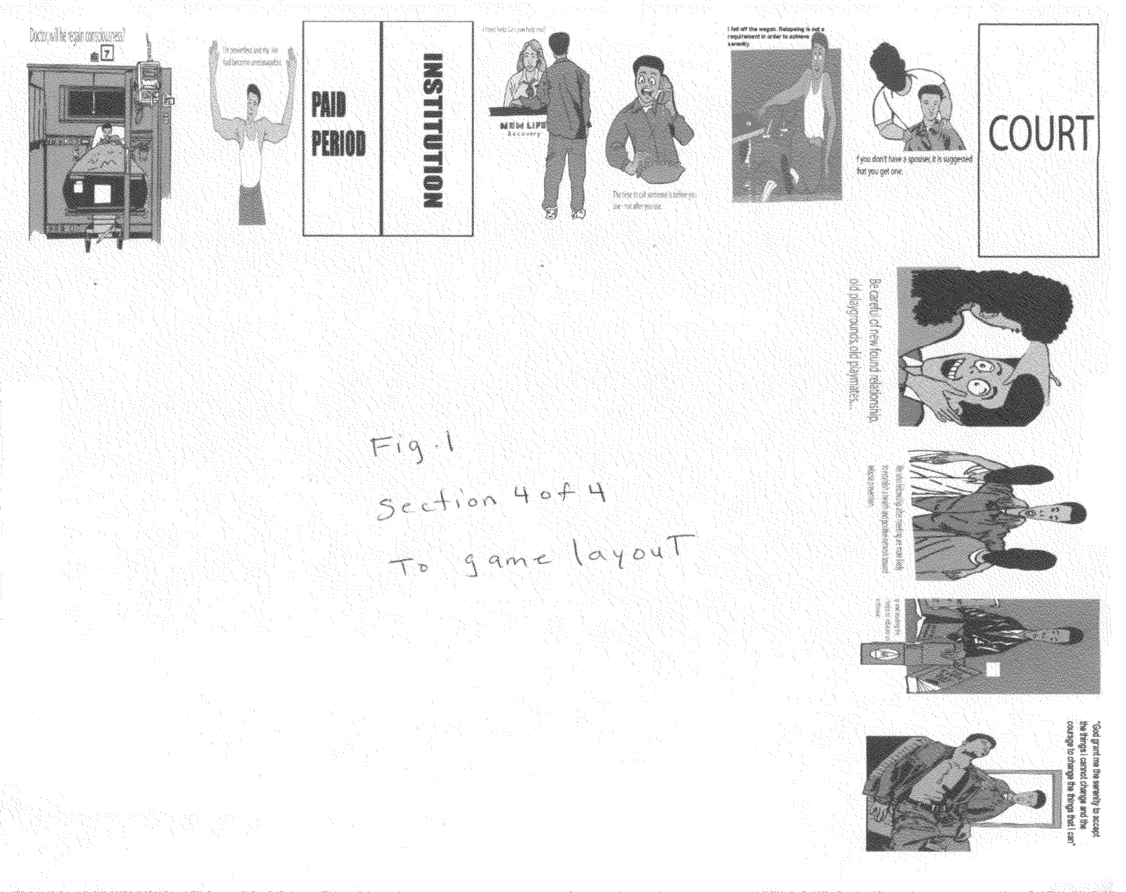

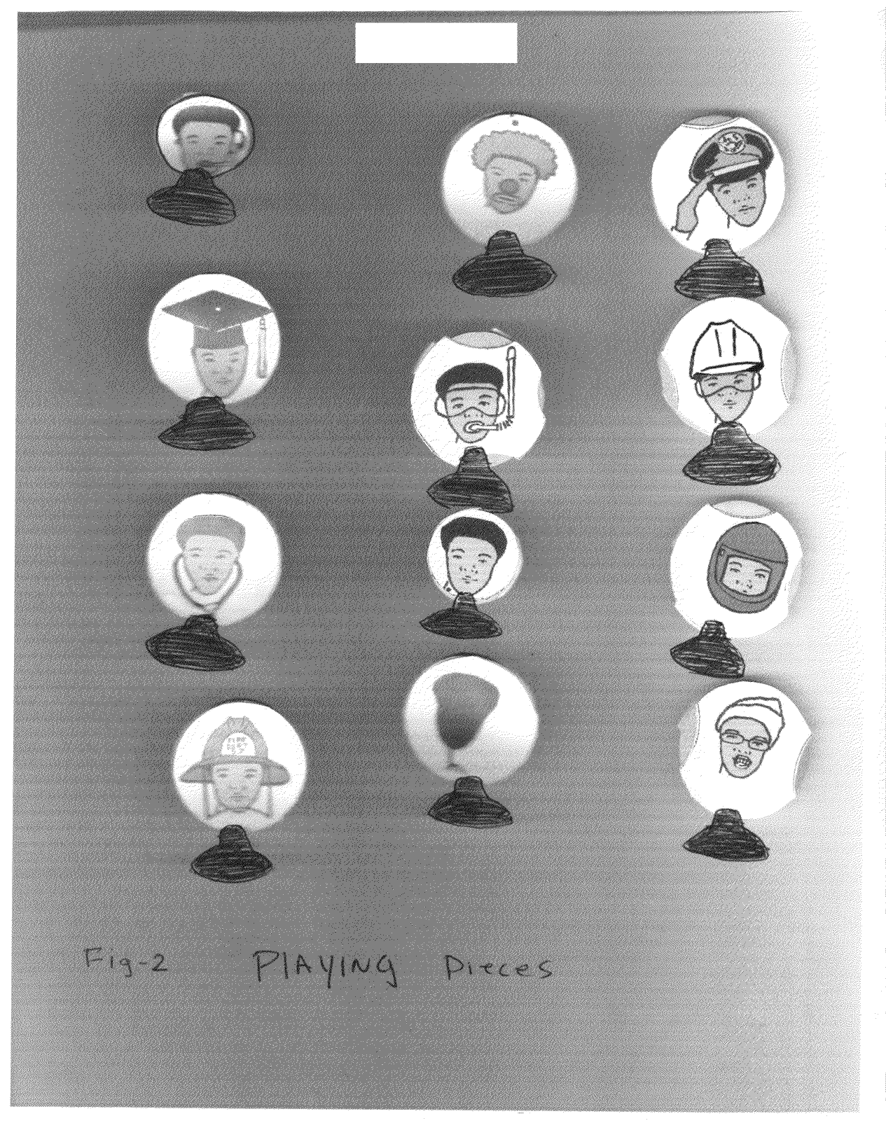

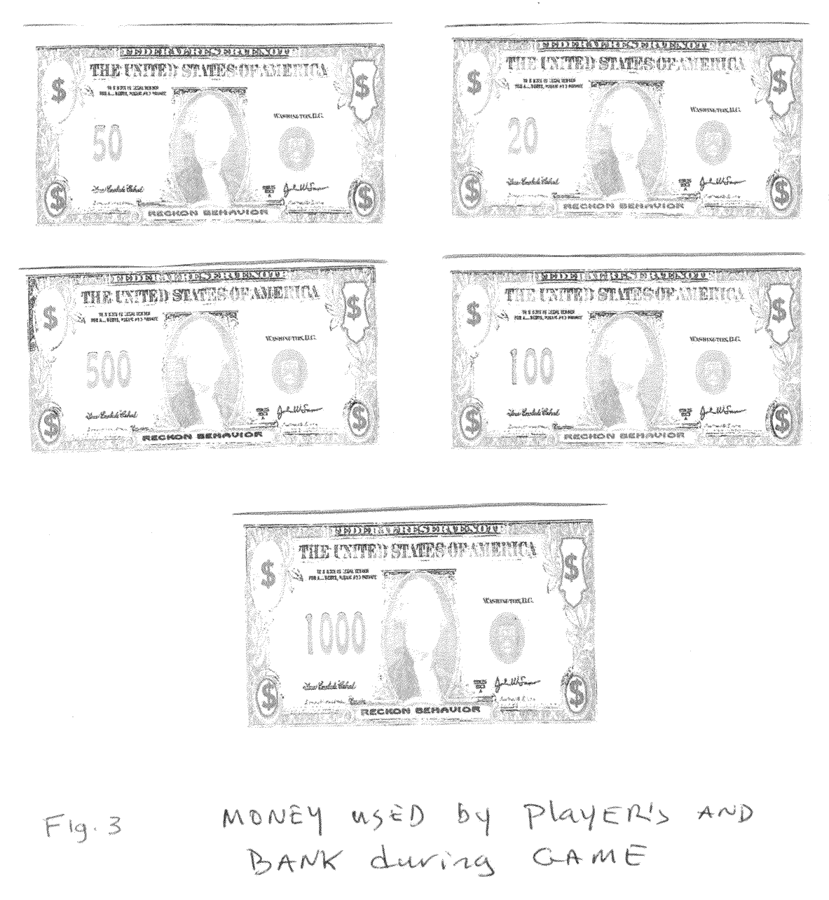

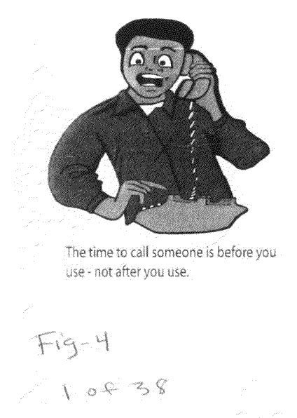

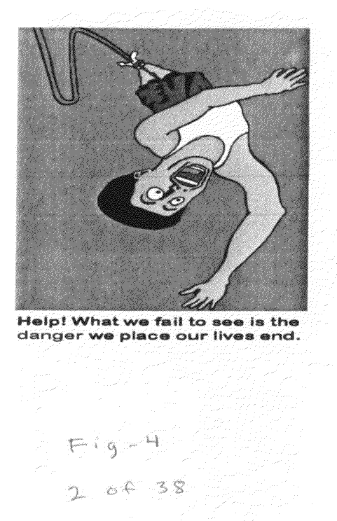

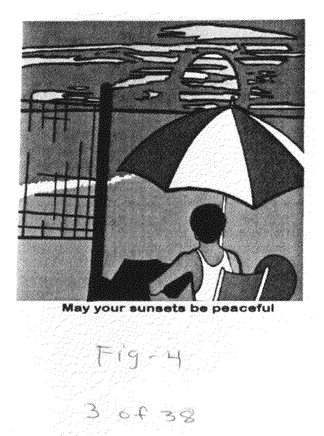

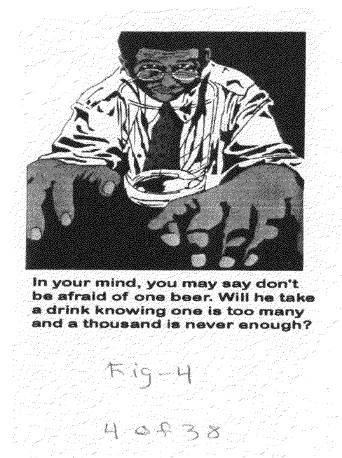

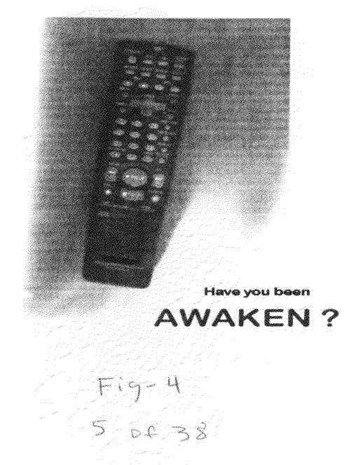

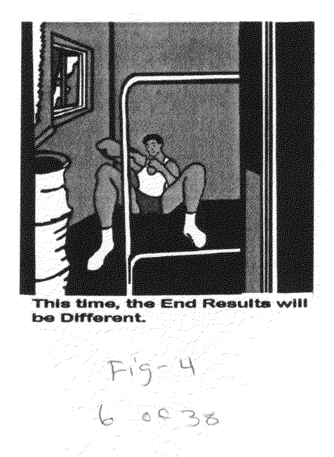

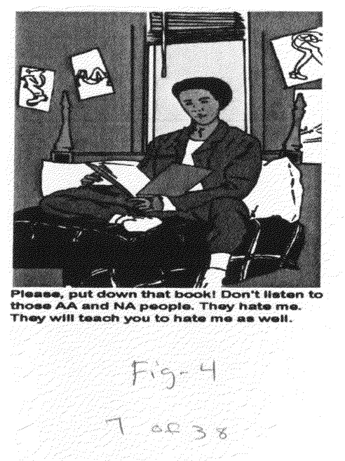

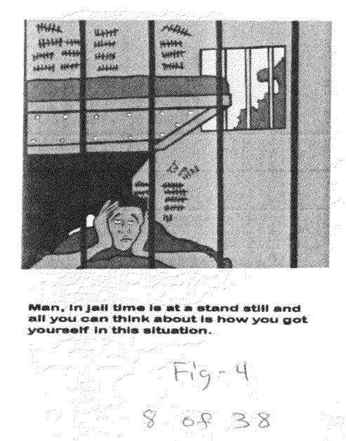

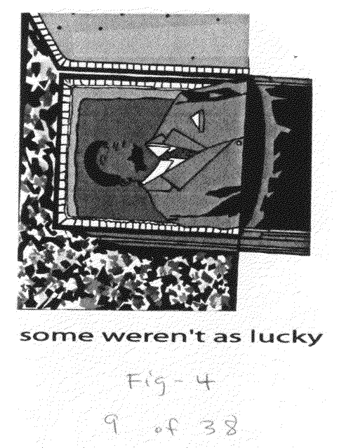

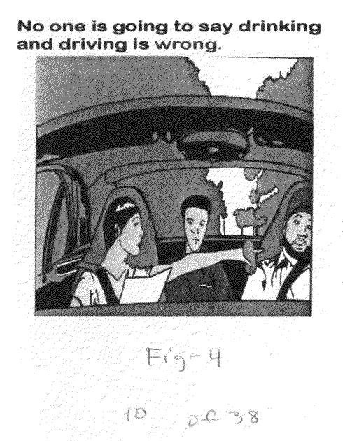

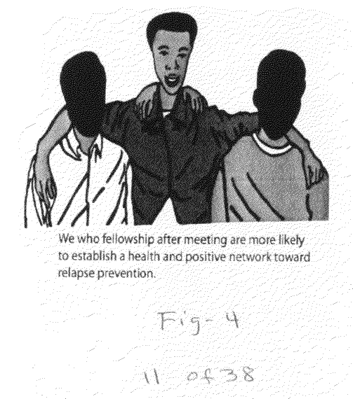

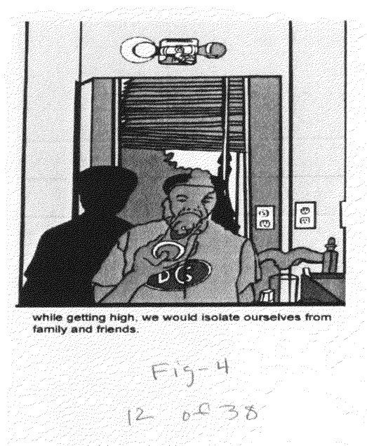

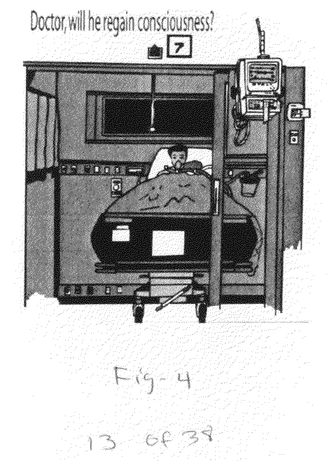

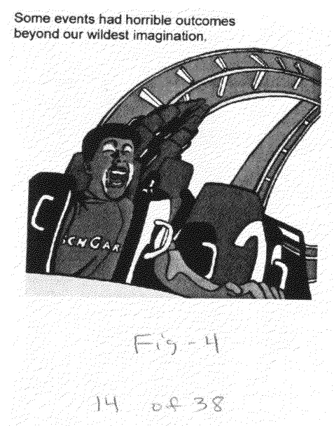

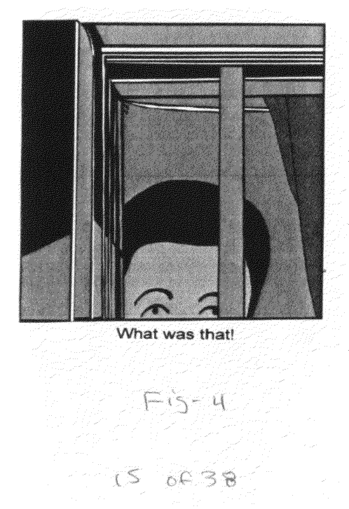

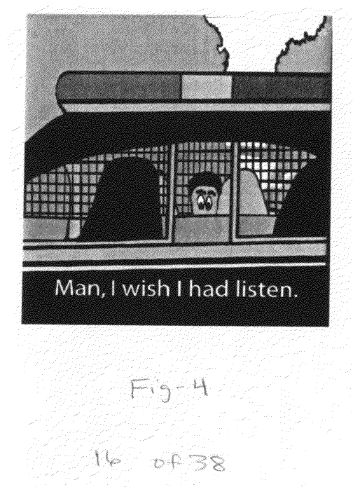

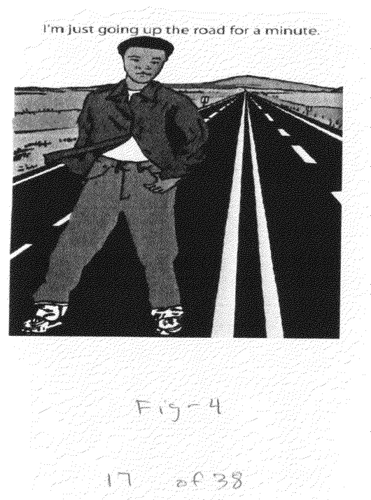

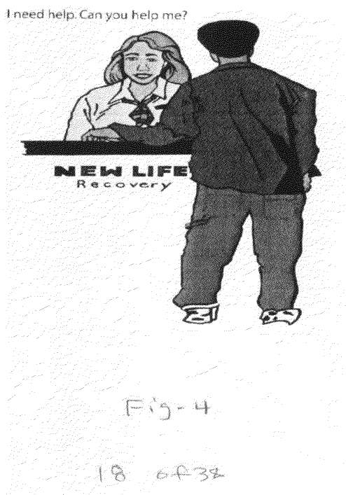

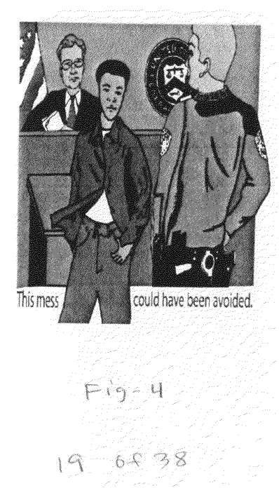

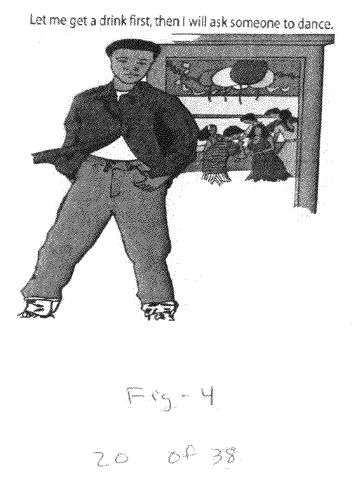

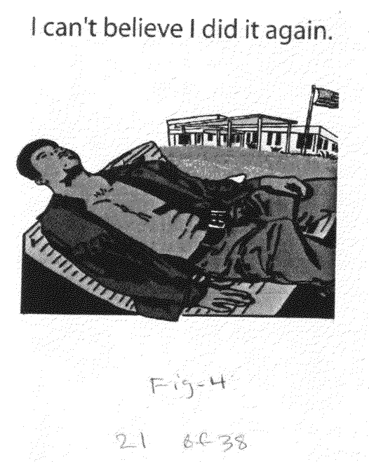

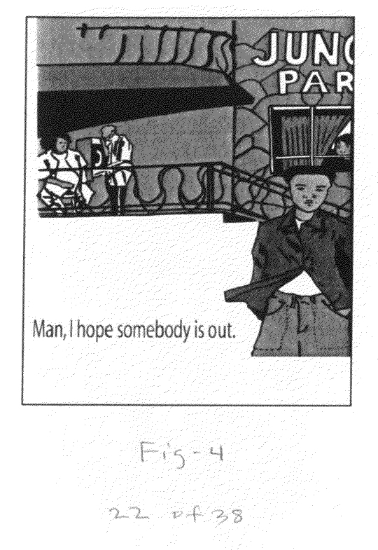

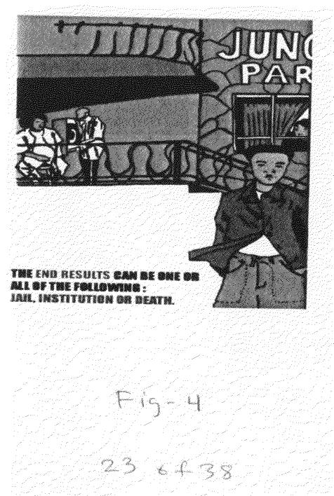

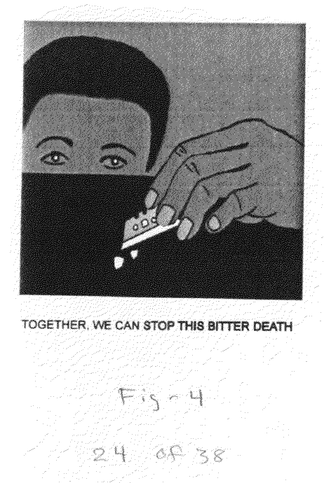

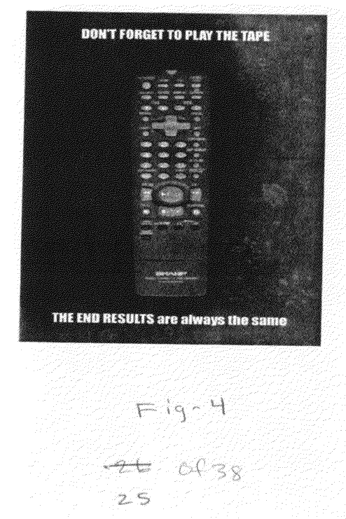

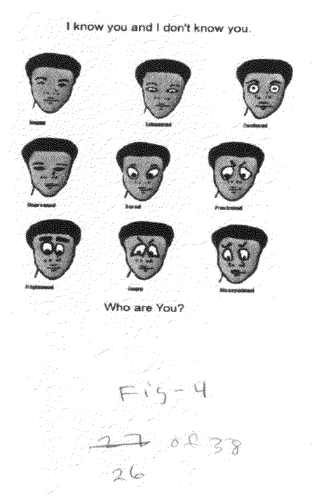

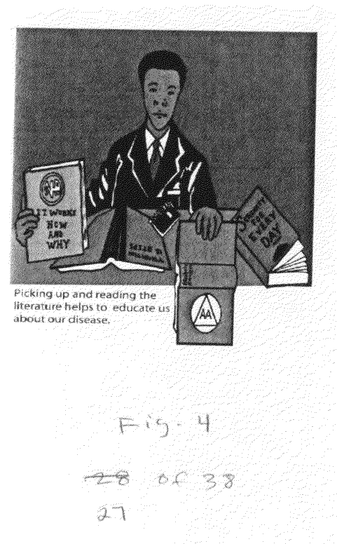

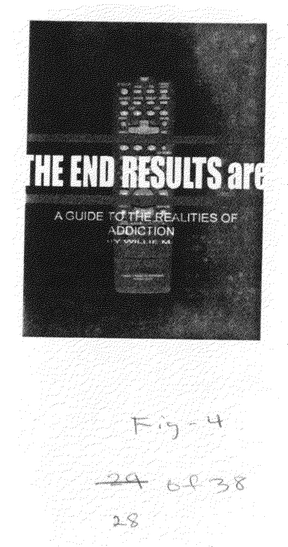

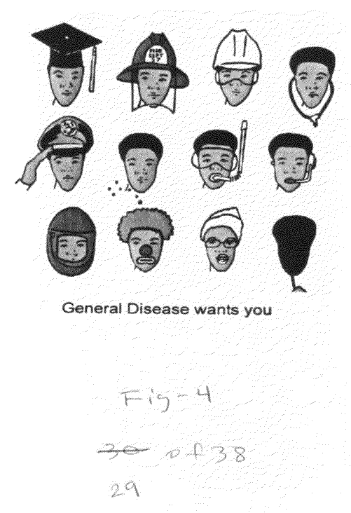

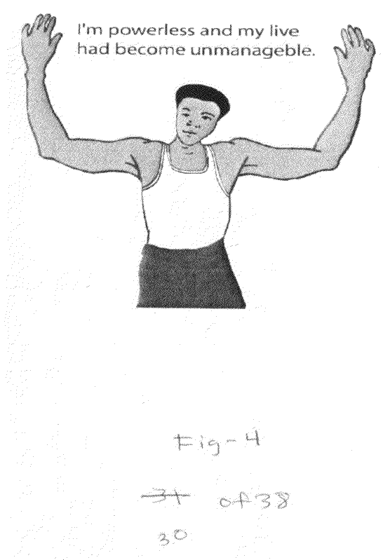

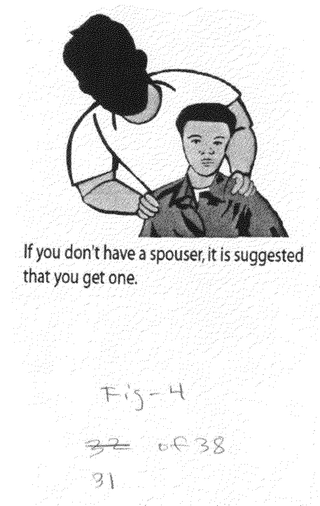

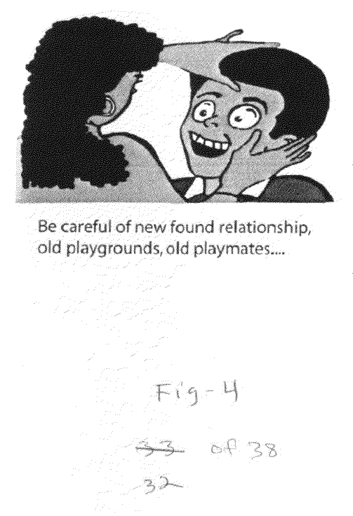

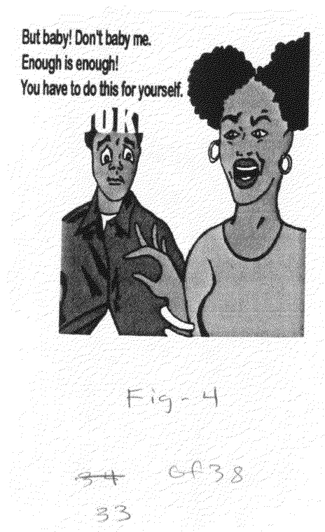

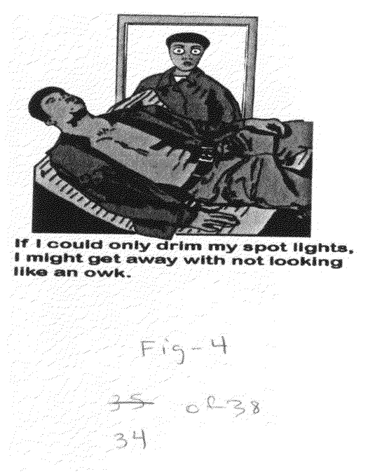

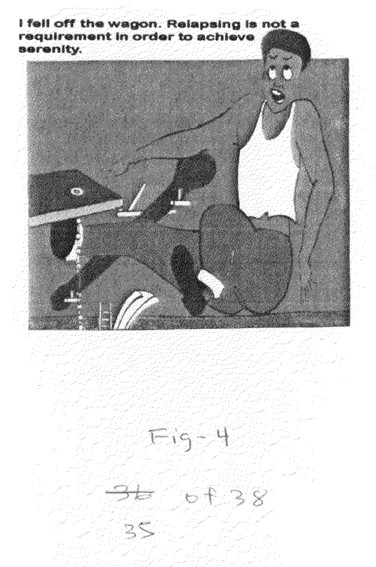

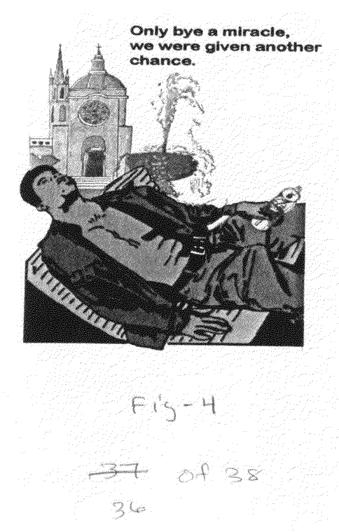

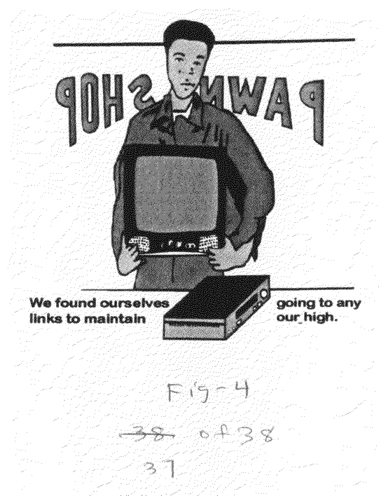

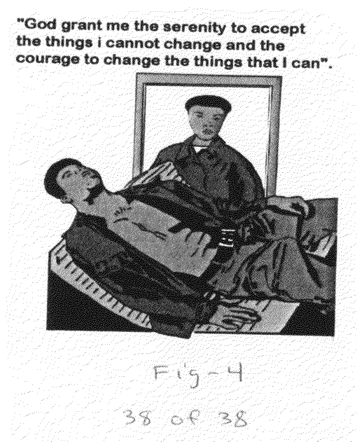

### DESCRIPTION OF THE PREFERRED EMBODIMENT

1. Game content sheet

2. Game preparation sheet

3. Playing the game sheet

4. explanation sheet for card's:
high risk behavior cards: 10 card's with 40 risk factors
pawn cards: 9 cards with 36 risk factors
jail cards: 10 cards with 40 risk factors
court cards: 7 cards with 28 risk factors
institution cards: 6 cards with 24 risk factors
option 1,2,3,4 cards: 50 cards

### Contents

1 Board
1 Deck of High Risk Behavior Cards
1 Deck of Court Cards
1 Deck of Jail Cards
1 Deck of Institution Cards
1 Deck of Pawn Cards
1 Set of Dice
1 set of Money each: $1000, $500, $100, $50 and $20 dollar denominations
1 Deck of 1,2,3,4 option Cards
1 set of player pieces
Number of players: 2 to 4
Ages: 10 to Adult
Approximate Playing Time: NO TIME LIMIT

### Preparation

Place the game board in the middle to the table.

Shuffle the cards by each group separately and place each group face down in a stack on the broad.

Each player rolls the dice to determine the order of each player ie 1,2,3,4 positions in the game to determine their salary per week.

One player will be elected to control the bank to pay out each individual salaries and collect fines ie. An individual is paid his or her salary each time they land on paid period according to the position of their play.

All players are started out with the same amount of cash in their accounts plus one paid period salary.

The amount of money given to each player will determine the amount of time the game run.

### Playing the Game

Each player begin in order of the position they hold 1,2,3,4.

A player rolls the dice to see how many spaces to move his or her piece follow by the other players.

If an individual lands on pay period, the bank will pay that individual the amount that individual rolls 1,2,3,4 from his or her selection from the pay period card. Each player has to give that individual $100 dollars.

Example: If you roll a 2, select pay period card and read amount to be paid for 2, This is the amount paid from the bank.

If an individual land on Jail, Court, High Risk Behavior or Institution ie, player is to roll the dice again to determine the amount to be paid to the bank. Amounts varies according to the nature of each event.

player will continue until: they finish, run out of money or meet some event that will take them out of the game.

Person with the most money at the end of the game is declared the winner

Players can play beyond the finish point into as many rounds desired until no other players have funds to continue

What is claimed:

1. Reckon Behavior is a board game that visually walks each player though the many possible situation resulting from high risk behavior. It is a game played for fun with A sole purpose of being educational about addiction and the choices we as individual Make daily.
Goals
The goal of Reckon Behavior is to give individual real life scerious of possible ending Results due to high risk taken behavior. The game will educate player regarding habits and patterns associated with high risk taken behavior. The participants in turn will relate Understand, and recognized how continued high risk taken behavior can only end with Jail, institution and or death.
To prevent people from developing an addiction
To help people overcome their addictions
To reduce the problems associated with addiction and high risk behavior
Objectives:
Increase awareness about the dangers of high risk behavior
Enlighten family members and participants through visually positive and Negative outcomes of high risk taking behavior
Decrease the factors that bring about Reckon Behavior due to poor judgment
In crease benefits gained from the knowledge not known by all making high Risk choices
Event Details
Reckon Behavior can be utilize nationwide in hospitals, rehab treatment, educational System, private home and business community ie. Participants can be divided into groups of two or four and each participant can relate, understand and recognize how Continued high risk taken behavior can only end in disaster.
Evaluation
Our aim is to educate and decrease the number of individual unaware of the risk Surrounding high risk behavior. Individually, participants may better address life Saving issues with better choices that could prevent jail, institution or death situations.
